(19) United States
(12) Patent Application Publication
(10) Pub. No.: US 2007/0095921 A1
(43) Pub. Date: May 3, 2007

(54) Secure substrate

(75) Inventor: Joseph D. Roth, Springboro, OH (US)

Correspondence Address: Christopher P. Ricci;Intellectual Property Section, Law Department, NCR Corporation, 1700 South Patterson Blvd., Dayton, OH, 45479-0001, US

(73) Assignee: NCR Corporation

(21) Appl. No.: 11/263,492

(22) Filed: Oct. 31, 2005

(51) Int. Cl. G06K 19/06

(52) U.S. Cl. 235/491

(57) ABSTRACT

A secure substrate comprises: (i) a carrier having a front surface extending from a first edge to a second edge opposite the first edge, and a rear surface opposite the front surface and also extending from the first edge to the second edge, the front surface and rear surface being mutually arranged to form a light guide; and (ii) a luminescent security tag incorporated within the carrier between the front surface and the rear surface and between the first edge and the second edge so that luminescence from the luminescent security tag is propagated by the light guide to at least one of the first edge and the second edge; thereby enabling edge reading of luminescence stimulated by radiation through the front or rear surface.

### BACKGROUND

The present invention relates to a secure substrate and to a method of reading the secure substrate.

With advances in printing technology, the use of clear substrates is becoming more widespread. One use of a clear substrate is in valuable media, particularly banknotes. Printing banknotes is expensive so it is desirable to ensure that they last as long as possible. By using a polymer substrate instead of the more conventional rag-based substrate, robust and wear-resistant banknotes can be created.

To avoid counterfeiting, banknotes include overt and covert security features. Overt security features may include raised printing, watermarks, holograms, and such like. Covert security features may include inks and dyes that fluoresce in the visible or infra-red regions of the spectrum. These inks and dyes are printed onto the surface of banknotes.

One type of security feature that has been proposed for use in banknotes is a security tag. These tags can take various forms, such as quantum dots, DNA tags, and such like.

One type of security tag that has recently been developed is based on small particles of rare earth doped glass, as described in U.S. patent application No. 2004/0262547, entitled “Security Labelling,” and U.S. patent application No. 2005/0143249, entitled “Security Labels which are Difficult to Counterfeit”, both of which are incorporated herein by reference. These rare earth doped particles can be incorporated in inks and printed onto banknotes. However, it is possible that a banknote containing these tags may lose some of the tags as a result of continued abrasion of the banknote during use.

### SUMMARY

According to a first aspect of the invention there is provided a secure substrate comprising: (i) a carrier having a front surface extending from a first edge to a second edge opposite the first edge, and a rear surface opposite the front surface and also extending from the first edge to the second edge, the front surface and rear surface being mutually arranged to form a light guide; and (ii) a luminescent security tag incorporated within the carrier between the front surface and the rear surface and between the first edge and the second edge so that luminescence from the luminescent security tag is propagated by the light guide to at least one of the first edge and the second edge.

By virtue of this aspect of the invention, a luminescent tag is incorporated within a substrate, thereby making it difficult for a counterfeiter to remove the tag. By having the luminescent tag enclosed within a substrate, the tag is protected from wear compared with surface mounted tags, and the tag is also protected from environmental influences.

The carrier may be a transparent medium, such as a clear polymer. Using an optically transparent medium as a carrier ensures that the luminescence is not absorbed by the carrier.

The luminescent security tag may be an inorganic pigment. One suitable inorganic pigment is a rare earth doped particle. The rare earth doped particle may comprise a glass matrix, such as borosilicate glass, doped with one or more rare earth ions. A rare earth (“RE”) doped glass particle is referred to herein as an “RE glass particle”. Many different compositions of glass may be suitable for use as the glass matrix. Glasses are generally inorganic substances that solidify from a molten state without crystallization, so that they have no long-range molecular order.

An RE glass particle may be transparent, and therefore difficult to see with the human eye. This could be an advantage if the RE glass particle is used as a covert security feature.

When an RE glass particle is used, the composition of the glass matrix may be chosen so that the refractive index of the RE glass particle matches the refractive index of the carrier. This should ensure that the RE glass particle will not be visible (or at least not easily visible) to the human eye. A further advantage of matching the refractive index of the RE glass particle with that of the carrier is that it reduces scattering of the luminescence as the luminescence travels through the carrier.

Other types of luminescent security tag may be used in addition to or instead of an RE glass particle. These luminescent security tags include organic pigments, other inorganic pigments, dyes, and metal ions (such as lanthanides).

The secure substrate may be (i) a media item (such as a container or such like), (ii) a laminar media item (such as banknotes, certificates, documents, CDs, DVDs, memories, credit cards, debit cards, loyalty cards, sheets, paper, card, or such like), (iii) part of a bound item (for example, pages from a book, a check book, a passport, or such like), or such like.

The luminescent security tag may be a fluorescent tag, a phosphorescent tag, or a tag including both fluorescent and phosphorescent materials.

Fluorescent materials (dyes and pigments) have a decay lifetime of 10⁻⁹ to 10⁻⁷ seconds (1 to 100 nanoseconds). The fluorescence from the security tag disappears very quickly after tag excitation ceases. Thus, detecting fluorescence is typically performed simultaneously with or immediately after excitation.

Phosphorescent materials (dyes and pigments) have a decay lifetime of 10⁻³ to 100 seconds. Thus the phosphorescence from the security tag persists for a relatively long time period after tag excitation ceases. Detecting phosphorescence can be done simultaneously with excitation. It is also possible to measure the phosphorescence after the excitation is removed. Measuring the phosphorescence after the excitation is removed adds to the security of a phosphorescent tag.

A time delay between excitation and detection provides several advantages. A time delay greater than half a microsecond (0.5 μsec) typically eliminates interference from fluorescence (because the fluorescence has decayed within that time delay).

The carrier may comprise a plurality of layers laminated together. The luminescent security tag may be located between two adjacent layers. By using a plurality of layers to create the carrier, incorporating the luminescent security tag within the carrier is simplified.

According to a second aspect of the invention there is provided a secure substrate comprising a luminescent tag completely enclosed by a carrier, the carrier being configured to propagate luminescence from the tag to an end edge in response to excitation received through a front surface disposed generally transverse to the end edge.

By virtue of this aspect, a security tag is embedded in a carrier and total internal reflection is used to enable edge reading of luminescence from the security tag.

According to a third aspect of the invention there is provided a method of manufacturing a secure substrate comprising: creating a light guide by providing a carrier having a front surface extending from a first edge to a second edge opposite the first edge, and a rear surface opposite the front surface and also extending from the first edge to the second edge, the front surface and rear surface being mutually arranged to form a light guide; and embedding a luminescent security tag within the carrier between the front surface and the rear surface and between the first edge and the second edge so that luminescence from the luminescent security tag is propagated by the light guide to at least one of the first edge and the second edge.

Creating a light guide may include laminating a plurality of sheets together to form the carrier. Embedding a luminescent security tag within the carrier may be implemented by locating the luminescent security tag between adjacent sheets prior to laminating the sheets.

Embedding a luminescent security tag may include locating the security tag in registration with inks to be applied (or already applied) to the front and/or rear surfaces of the carrier. By locating the security tag in registration with inks, radiation used to excite the security tag may be filtered by the ink. This may change the luminescence from the security tag. Thus, a security tag located in registration with ink printed on a surface of the carrier may have a different response to the same (or a similar) security tag located where there is no ink present.

According to a fourth aspect of the invention there is provided a method of reading a security tag incorporated within a carrier having a front surface extending from a first edge to a second edge opposite the first edge, and a rear surface opposite the front surface and also extending from the first edge to the second edge, the method comprising: exciting the tag by passing radiation through the front surface; and detecting luminescence from the tag emitted from the first edge.

By virtue of this aspect of the invention, a luminescence detector can be located at a different position (for example, generally transverse) to an excitation source. This enables a high speed banknote reader to illuminate a banknote through a front surface and to detect luminescence from a side edge.

According to a fifth aspect of the invention there is provided a secure substrate comprising a plurality of sheets, the sheets being laminated together, and a security tag located between adjacent sheets prior to the sheets being laminated so that the tag is encapsulated within the secure substrate.

These and other aspects of the present invention will be apparent from the following specific description, given by way of example, with reference to the following drawings.

### BRIEF DESCRIPTION OF THE DRAWINGS

FIG. 1 is a simplified front view of a secure substrate according to one embodiment of the present invention;

FIG. 2 is a simplified rear view of the secure substrate of FIG. 1;

FIG. 3 is a simplified side view of the secure substrate of FIG. 1;

FIG. 4 is a schematic front view of a detection system for use with the secure substrate of FIG. 1;

FIG. 5 is a schematic side view of the detection system of FIG. 4;

FIG. 6 is a diagram illustrating steps involved in fabricating a secure substrate according to another embodiment of the present invention; and

FIG. 7 is a diagram illustrating a spatial code incorporated in a laminated secure substrate according to yet another embodiment of the present invention, and luminescence associated with the spatial code.

### DETAILED DESCRIPTION

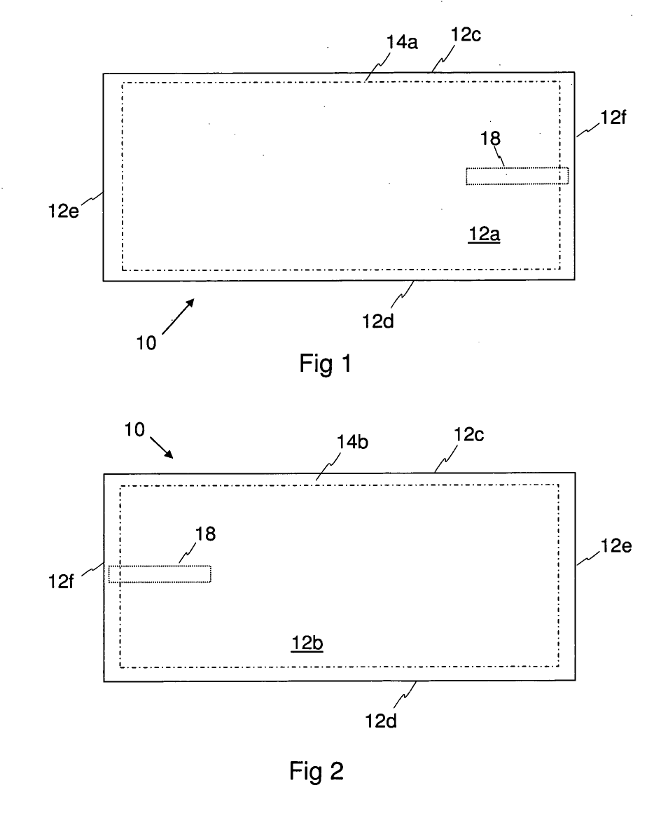

Reference is first made to FIGS. 1 and 2, which are front and rear views respectively of a secure substrate 10 in the form of a banknote according to one embodiment of the present invention.

The banknote 10 comprises a clear, polymer carrier 12 having a front surface 12a (FIG. 1) on which is printed conventional banknote information (illustrated schematically by broken line 14a), such as issuing authority, currency, denomination, serial number, and such like. The polymer carrier 12 has a rear surface 12b (FIG. 2) also printed with conventional banknote information (illustrated schematically by broken line 14b). The front and rear surfaces 12a,b have parallel long edges 12c,d and parallel short edges 12e,f.

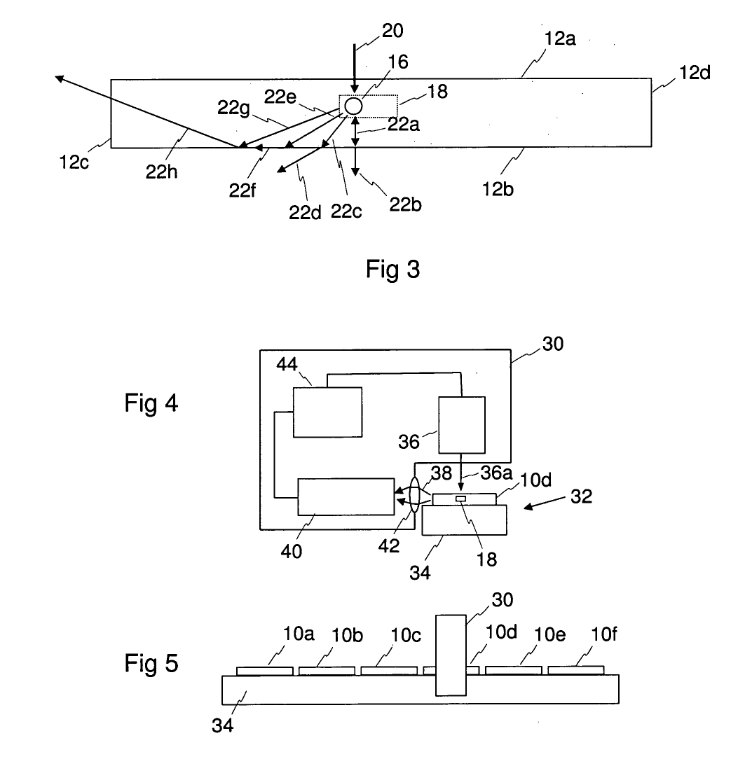

The polymer carrier 12 encloses a plurality of luminescent security tags 16 (FIG. 3) within a security area 18. The security tags 16 are rare-earth doped borosilicate glass particles having a typical size of approximately fifty microns (50 μm). The particular rare-earth dopant used in this embodiment is 3 mol % of Europium. Details about how to manufacture such tags are provided in U.S. patent application No. 2005/0143249, entitled “Security Labels which are Difficult to Counterfeit”.

Security area 18 is sandwiched between the front and rear surfaces 12a,b as best seen in FIG. 3. Furthermore, the conventional banknote information 14a,b partially overlaps the security area 18.

Each security tag 16 luminesces when excited by radiation of sufficient energy to populate higher energy level states within the security tag 16. As illustrated in FIG. 3, radiation 20 stimulates omni-directional luminescence 22 from the security tag 16. It should be appreciated that for purposes of illustration, in FIG. 3 the distance between the front and rear surfaces 12a,b has been greatly enlarged compared with the distance between the long edges 12c,d; and the size of the security tag 16 has been greatly enlarged relative to the size of the security area 18.

Some luminescence (illustrated by arrow 22a) strikes the rear surface 12b at an angle normal to the rear surface 12b. Most of this luminescence (as shown by arrow 22b) passes straight through the rear surface 12b, but some luminescence is reflected back to the security tag 16.

Some luminescence (illustrated by arrow 22c) strikes the rear surface 12b at an angle less than the critical angle, so that most of this luminescence (as shown by arrow 22d) is refracted as it passes through the rear surface 12b.

Some luminescence (illustrated by arrow 22e) strikes the rear surface 12b at the critical angle, so that most of this luminescence (as shown by arrow 22f) passes along the rear surface 12b.

Some luminescence (illustrated by arrow 22g) strikes the rear surface 12b at an angle greater than the critical angle, so that most of this luminescence (as shown by arrow 22h) is reflected back at the angle of incidence. This luminescence continues to be reflected within the polymer carrier 14 (by total internal reflectance) until it exits via the long edge 12c.

It will now be appreciated that both the front surface 12a and the rear surface 12b act as a refractive boundary to luminescence emitted from the security tags 16. This ensures that the banknote 10 acts as a light guide (or a light pipe) to convey luminescence from the security tags 16 in the security area 18 towards the long edges 12c,d.

Reference is now made to FIG. 4 and FIG. 5, which are schematic front and side views respectively of a detection system 30 for use with the banknote 10.

The detection system 30 is mounted at a banknote transport device 32 that transports a sequence of banknotes 10 (labeled 10a to 10f) on conveyor belt 34 with either the front surface 12a or the rear surface 12b facing the conveyor belt 34. The conveyor belt 34 transports the banknotes 10 at relatively high speed.

The detection system 30 comprises an illumination source 36 in the form of a pulsed LED emitting a narrow band of radiation at approximately 390 nm. The illumination source 36 is aligned so that the emitted radiation 36a is directed towards the security area 18 of the banknote 10 underneath the illumination source 36.

Luminescence 38 stimulated by the radiation 36a is propagated along the carrier 12 by total internal reflection from the front surface 12a and the rear surface 12b. This luminescence 38 exits from the long edges 12c, 12d. Adjacent one of the long edges 12c is a detector 40 having a collecting lens 42 for collecting the luminescence 38 emitted from the long edge 12c of the banknote 10d nearest the detector 40.

Both the illumination source 36 and the detector 40 are controlled by a controller 44 that is synchronized with the conveyor belt 34 and manages the timing of the illumination source 36 and the detector 40. This ensures that the illumination source 36 is activated at a correct time for illuminating the security area 18 in each banknote 10 as it passes thereunder.

The controller 44 also ensures that a correct delay period elapses to allow background fluorescence (if there is any) from the banknote 10 to decay before the luminescence 38 is measured; however, this delay is not so great that the banknote 10 moves beyond the collecting lens 42. The length of delay required, if any, may limit the speed at which the conveyor belt 34 can move if the illumination source 36 and the detector 40 are arranged in the same plane, as shown in FIGS. 4 and 5. However, the detector 40 may be laterally displaced along the conveyor belt 34 from the illumination source 36 to ensure that the conveyor belt speed is unaffected by the length of delay required. By offsetting the illumination source 36 and the detector 40, the speed at which the banknote 10 is traveling, and the physical distance between the illumination source 36 and the detector 40 determines the length of the delay between excitation and detection.

The controller 44 compares the luminescence detected with a pre-defined luminescent code associated with genuine banknotes to determine if the banknote 10 is genuine.

For added security, the security area 18 may include security tags 16 that luminesce with a multi-level code. One level may indicate the banknote luminescence signature, another level may indicate a unique serial number associated with that banknote. Thus, all banknotes of the same type will have the same banknote luminescent signature, but each of these banknotes will have a different serial number. The controller 44 may optically read a serial number from the conventional banknote information 14a and compare this with the unique serial number indicated by the luminescence measured by the detector 40. If the two do not match, then the detector 40 would indicate that a potentially counterfeit banknote has been detected.

The security area 18 in the banknote 10 allows two levels of interrogation to be performed. At a retail location, for example, an attendant at a point of sale terminal may use a simple, inexpensive, near-Ultra-Violet (near-UV) light or UV light to illuminate the security area 18 while viewing an edge of the banknote to verify that luminescence is emitted. At a bullion center, a high speed detector, such as that described with reference to FIGS. 4 and 5, may be used for high speed validation of the same banknotes, which provides a much greater level of security.

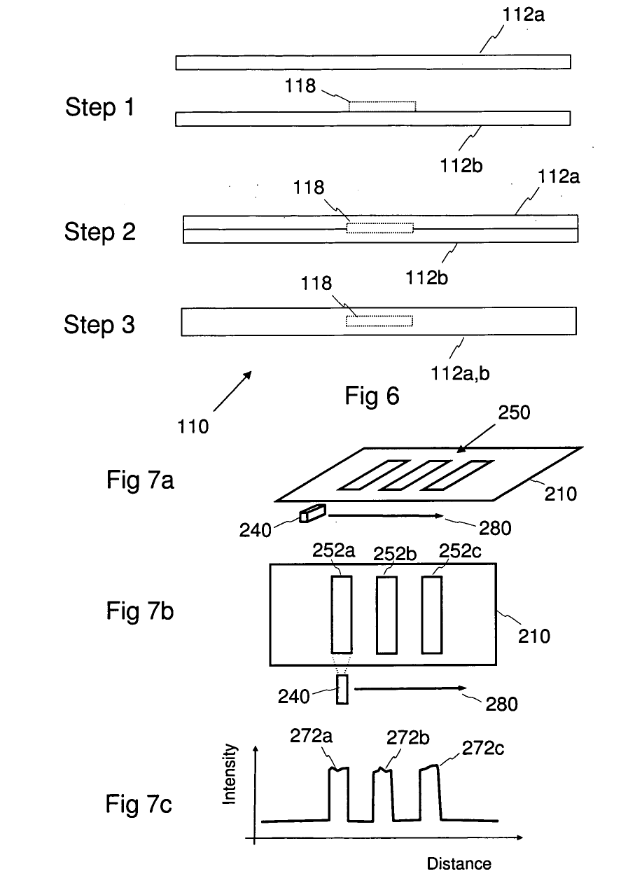

Reference is now made to FIG. 6, which is a diagram illustrating a secure substrate 110 according to another embodiment of the present invention. In FIG. 6, the secure substrate 110 (in the form of a banknote) is fabricated by laminating two layers of polymer 112a,b (Step 1). Security tags are placed in a security area 118 between the two layers 112a,b, and then the layers are laminated (Step 2) so that a single banknote 110 (Step 3) is formed that completely encloses the security area 118. This process simplifies incorporation of the tags 16 into the banknote 110.

Laminating two layers together allows patterns of tags to be placed between the layers, as illustrated in FIGS. 7a and 7b, which are perspective and plan views respectively of a banknote 210 incorporating a spatial code 250 laminated between two layers. The spatial code 250 is a two dimensional barcode, where the bars 252a,b,c are formed by security tags 16.

Using a spatial code has two main advantages. Firstly, different emission spectra are produced by exciting different areas on the banknote 210. Secondly, a bar of tags creates a pulse of luminescence as each bar 252 moves past a detector 240. A series of bars (252a to 252c) formed by tags 16 creates a sequence of pulses (272a to 272c) of luminescence as the detector 240 moves past the barcode 250 in the direction of arrow 280, as shown in FIG. 7c. This enables invisible barcodes (or other spatial codes) to be created within the banknote 210. Luminescence from these invisible barcodes can be read by the detector 240 at the edge of the banknote 210. This provides second level coding, for example, to indicate the denomination of the banknote. The detector 240 has a narrow acceptance angle for luminescence emitted from the individual bars 252 to ensure that luminescence from only one bar is measured by the detector 240 at any given time.

Various modifications may be made to the above-described embodiments within the scope of the present invention, for example, in other embodiments different or additional banknote information (for example, serial number, printing date, printing location, and such like) may be encoded by the security tags, particularly using a spatial code.

In other embodiments, different security tags 16 may be used than those described, such as radio frequency tags, organic pigments, quantum dots, or such like.

In other embodiments, different illumination sources and/or detectors may be used, depending on the luminescence to be stimulated and detected.

In other embodiments, the substrate may not be a banknote but may be another valuable media item, such as a check.

In other embodiments, the detector 240 may include a fiber-optic pipe for ensuring that the acceptance angle is small enough to discriminate between luminescence from adjacent bars in a spatial code.

In other embodiments, security tags 16 smaller or larger than fifty microns may be used.

In other embodiments, an ink or other coating may be applied to a surface of the secure substrate in registration with the security tags. In one such embodiment a UV absorbing ink or coating may be applied to a front surface of the secure substrate to absorb some of the excitation radiation from a broadband excitation source prior to the excitation radiation reaching the security tags, thereby affecting the luminescence from the security tags.

In other embodiments, the luminescent security tag or tags may be mixed with carrier material and then the mixture extruded, thereby producing a carrier incorporating the luminescent security tag or tags.

In other embodiments, the security tag or tags may be located in a different area of the secure substrate than the area shown in the drawings.

What is claimed is:

1. A secure substrate comprising:
(i) a carrier having a front surface extending from a first edge to a second edge opposite the first edge, and a rear surface opposite the front surface and also extending from the first edge to the second edge, the front surface and rear surface being mutually arranged to form a light guide; and
(ii) a luminescent security tag incorporated within the carrier between the front surface and the rear surface and between the first edge and the second edge so that luminescence from the luminescent security tag is propagated by the light guide to at least one of the first edge and the second edge.

2. A secure substrate according to claim 1, wherein the carrier comprises a transparent polymer.

3. A secure substrate according to claim 1, wherein the luminescent security tag includes a pigment.

4. A secure substrate according to claim 3, wherein the pigment is an inorganic pigment.

5. A secure substrate according to claim 4, wherein the inorganic pigment comprises a matrix doped with a rare earth element.

6. A secure substrate according to claim 5, wherein the matrix composition matches the refractive index of the carrier.

7. A secure substrate according to claim 1, wherein the carrier comprises a plurality of layers laminated together.

8. A secure substrate according to claim 1, wherein the secure substrate includes a plurality of luminescent security tags arranged in a spatial formation to provide a spatial code.

9. A secure substrate comprising a luminescent tag completely enclosed by a carrier, the carrier being configured to propagate luminescence from the tag to an end edge in response to excitation received through a front surface disposed generally transverse to the end edge.

10. A method of manufacturing a secure substrate comprising:
creating a light guide by providing a carrier having a front surface extending from a first edge to a second edge opposite the first edge, and a rear surface opposite the front surface and also extending from the first edge to the second edge, the front surface and rear surface being mutually arranged to form a light guide; and
embedding a luminescent security tag within the carrier between the front surface and the rear surface and between the first edge and the second edge so that luminescence from the luminescent security tag is propagated by the light guide to at least one of the first edge and the second edge.

11. A method according to claim 10, wherein creating a light guide includes laminating a plurality of sheets together to form the carrier.

12. A method according to claim 10, wherein embedding a luminescent security tag within the carrier is implemented by locating the luminescent security tag between adjacent sheets prior to laminating the sheets.

13. A method according to claim 10, wherein embedding a luminescent security tag within the carrier includes locating the security tag in registration with inks on the front and/or rear surfaces of the carrier.

14. A method of reading a security tag incorporated within a carrier having a front surface extending from a first edge to a second edge opposite the first edge, and a rear surface opposite the front surface and also extending from the first edge to the second edge, the method comprising:
exciting the tag by passing radiation through the front surface; and
detecting luminescence from the tag emitted from the first edge.

15. A secure substrate comprising a plurality of sheets, the sheets being laminated together, and a security tag located between adjacent sheets prior to the sheets being laminated so that the tag is encapsulated within the secure substrate.

16. A secure substrate according to claim 15, wherein the security tag is an inorganic pigment comprising a matrix doped with a rare earth element.
